(19) United States
(12) Patent Application Publication
(10) Pub. No.: US 2025/0121745 A1
(43) Pub. Date: Apr. 17, 2025

(54) Race Car Seat Lift

(71) Applicant: Brad Meador, Hackett, AR (US)

(72) Inventor: Brad Meador, Hackett, AR (US)

(21) Appl. No.: 18/487,093

(22) Filed: Oct. 15, 2023

(51) Int. Cl. B60N 2/16

(52) U.S. Cl. CPC B60N 2/1665

(57) ABSTRACT

A race car seat lift comprising of a seat which is pivotally connected to the frame of the racecar wherein a pneumatic inflatable bag is located beneath the seat. The pneumatic inflatable bag is attached to a switch within reach of the driver. When the driver activates the switch, compressed air inflates the bag, resulting in the seat lifting from its resting position. This lifted position allows the driver to get out of the race car seat more easily.

### BACKGROUND OF THE INVENTION

Most race cars sit low to the ground as a means to improve aerodynamics. However, this results in the driver sitting very low to the ground which can result in difficulties when getting out of the race car. The present subject addresses this difficulty of getting out of a race car.

### SUMMARY OF THE INVENTION

In the following description, numerous specific details are set forth to clearly describe various specific embodiments disclosed herein. One skilled in the art, however, will understand that the presently claimed invention may be practiced without all of the specific details discussed below. In other instances, well known features have not been described so as not to obscure the invention.

As described herein, the term “pivotally connected” shall be used to describe a situation wherein two or more identified objects are joined together in a manner that allows one or both of the objects to pivot, and/or rotate about or in relation to the other object in either a horizontal or vertical manner.

As described herein, the term “removably coupled” and derivatives thereof shall be used to describe a situation wherein two or more objects are joined together in a non-permanent manner so as to allow the same objects to be repeatedly joined and separated.

Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

The present subject matter is a race car seat lift comprises of a seat which is pivotally connected to the frame of the racecar wherein a pneumatic inflatable bag is located beneath the seat. The pneumatic inflatable bag is attached to a switch within reach of the driver. When the driver activates the switch, compressed air inflates the bag, resulting in the seat lifting from its resting position.

In some embodiments, the present subject matter uses electric solenoids to control the air pressure. In other embodiments, small hydraulic rams may be used on both sides attached to the frame of seat to chassis. In another embodiment, the present subject matter may be cable driven by an electric motor or centralized hydraulic ram.

The foregoing detailed description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation.

The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom.

### BRIEF DESCRIPTION OF DRAWINGS

FIG. 1 shows a perspective view of the race car seat in the lowered position.

FIG. 2 shows a perspective view of the race car seat in the raised position.

FIG. 3 shows a top view of the race car seat in the lowered position.

FIG. 4 shows a top view of the race car seat in the raised position.

FIG. 5 shows a top view of the pneumatic inflatable bag located beneath the race car seat.

FIG. 6 shows a perspective view of the switch which activates the pneumatic inflatable bag.

FIG. 7 shows a perspective view of the seat raised after the switch has been activated.

### DETAILED DESCRIPTION OF THE INVENTION

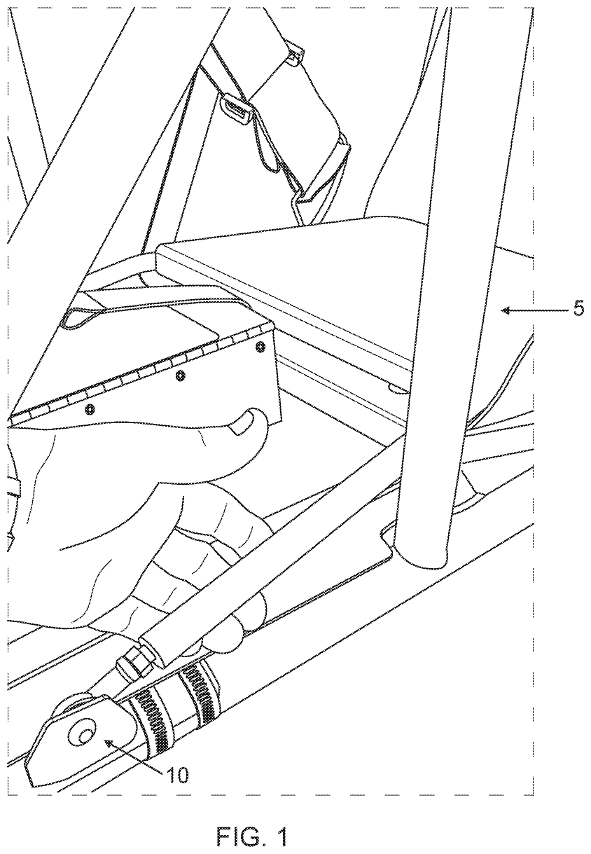

FIG. 1 shows a perspective view of the race car seat 5 in the lowered position, wherein the race car seat is pivotally connected to the frame 10.

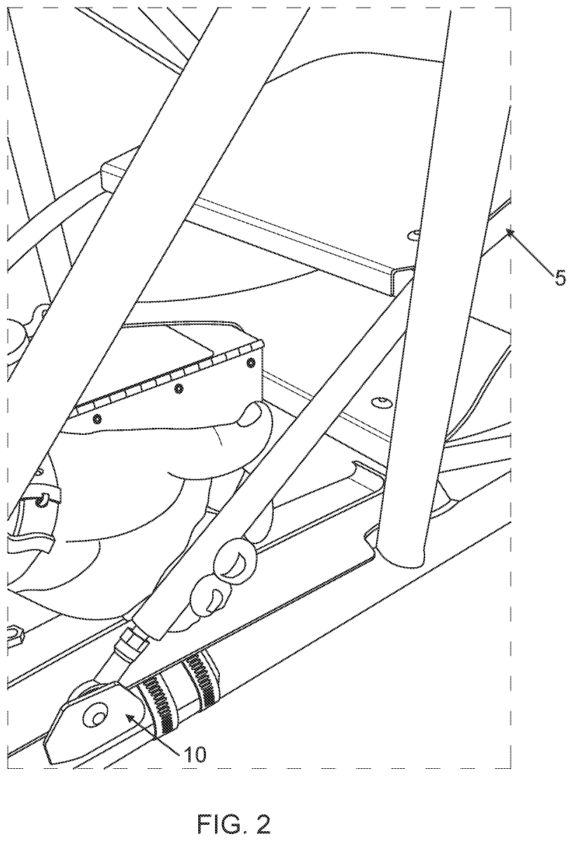

FIG. 2 shows a perspective view of the race car seat 5 in the raised position, wherein the seat is pivotally connected to the frame 10. The race car seat is pivotally connected in such a manner as to allow the seat to be raised towards the front of the vehicle which allows the driver to get out of the race car.

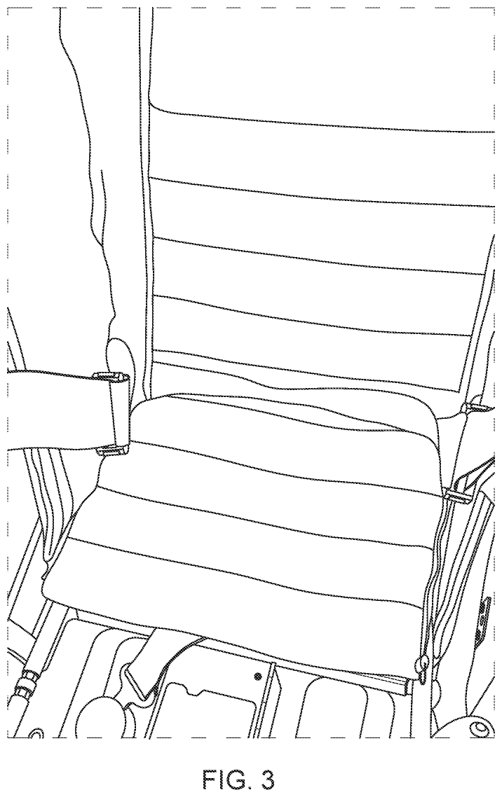

FIG. 3 shows a top view of the race car seat in the lowered position, wherein a seat cover is placed on the metal race car seat.

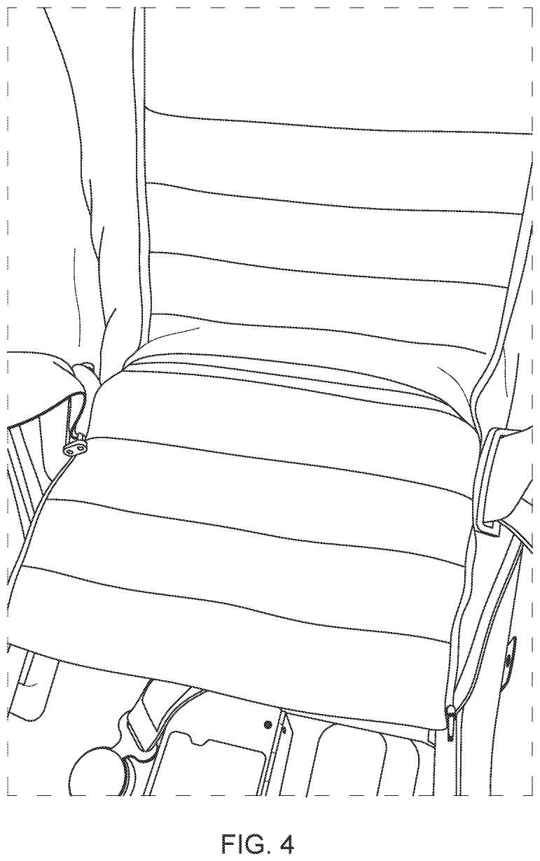

FIG. 4 shows a top view of the race car seat in the raised position, wherein a seat cover is placed on the metal race car seat.

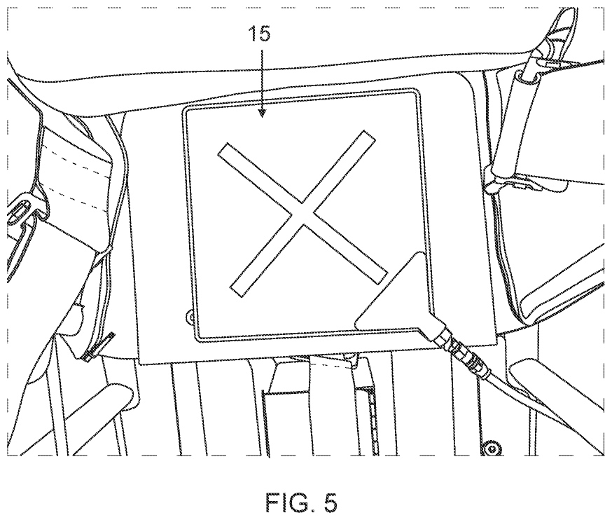

FIG. 5 shows a top view of the pneumatic inflatable bag 15 located beneath the race car seat, wherein the pneumatic inflatable bag 15 lifts race car 5 into a position that is easier for the driver to get out of the seat.

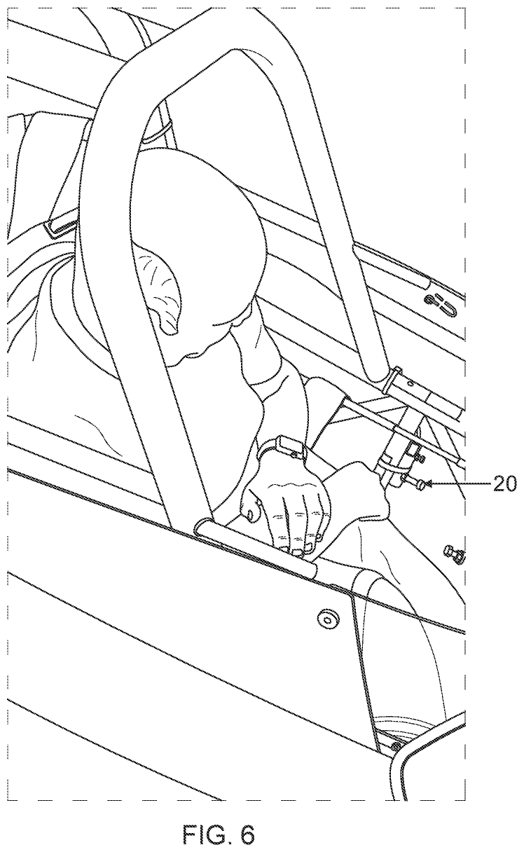

FIG. 6 shows a perspective view of the switch 20 which activates the pneumatic inflatable bag 15, wherein the driver presses the switch to send compressed air into the pneumatic inflatable bag.

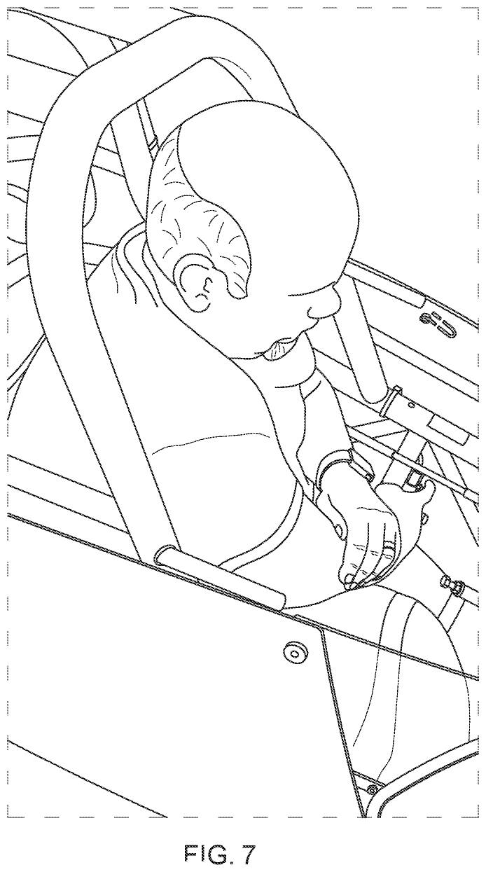

FIG. 7 shows a perspective view of the seat raised after switch 20 has been activated, wherein the driver is in a more elevated position to get out of the driver's seat.

1. A race car seat lift comprising of a race car seat, frame, pneumatic inflatable bag, and switch.

2. The race car seat lift comprising of the race car seat, frame, pneumatic inflatable bag, and switch as in claim 1, wherein the race car seat is pivotally connected to the frame in a manner that lifts towards the front of the vehicle.

3. The race car seat lift comprising of the race car seat, frame, pneumatic inflatable bag, and switch as in claim 1, wherein the switch activates the pneumatic inflatable bag.

4. The race car seat lift comprising of the race car seat, frame, pneumatic inflatable bag, and switch as in claim 3, wherein the pneumatic inflatable bag raises the race car seat towards the front of the vehicle.

5. A method of manufacturing a race car seat lift comprising of a race car seat, frame, pneumatic inflatable bag, and switch.

6. The method of manufacturing the race car seat lift comprising of the race car seat, frame, pneumatic inflatable bag, and switch as in claim 5, wherein the race car seat is pivotally connected to the frame in a manner that lifts towards the front of the vehicle.

7. The method of manufacturing the race car seat lift comprising of the race car seat, frame, pneumatic inflatable bag, and switch as in claim 5, wherein the switch activates the pneumatic inflatable bag.

8. The method of manufacturing the race car seat lift comprising of the race car seat, frame, pneumatic inflatable bag, and switch as in claim 7, wherein the pneumatic inflatable bag raises the race car seat towards the front of the vehicle.
